(19) United States
(12) Patent Application Publication
(10) Pub. No.: US 2020/0194186 A1
(43) Pub. Date: Jun. 18, 2020

(54) Electrolytic Capacitor

(71) Applicant: Lelon Electronics Corp., Taichung City (TW)

(72) Inventors: Shui-Yuan Lin, Taichung City (TW); Chung-Ming WU, Taichung City (TW)

(21) Appl. No.: 16/217,391

(22) Filed: Dec. 12, 2018

(51) Int. Cl. H01G 9/025; H01G 9/042; H01G 9/00; H01G 9/008

(52) U.S. Cl. CPC H01G 9/025; H01G 9/042; H01G 2009/0014; H01G 9/008; H01G 9/0036

(57) ABSTRACT

An electrolytic capacitor includes a core package formed by stacking and rolling an anode foil, a cathode foil, a plurality of paper spacers, and two terminal leads. The core package includes a solid electrolyte layer. The solid electrolyte layer is impregnated with an electrolytic solution. The electrolytic solution includes an ester compound and a sulfone compound. A content of the ester compound is more than 30% by mass. A content of the sulfone compound is more than 40% by mass. The sum of the contents of the ester compound and the sulfone compound is larger than 90% by mass. Thus, an electrolytic capacitor with excellent reliability is provided.

### BACKGROUND OF THE INVENTION

The present invention relates to a capacitor and, more particularly, to an electrolytic capacitor.

Capacitors are most commonly used passive elements and are used in various electronic products. With the development of electronic products, capacitors with a low equivalent series resistance (ESR) have wide applications, particularly low ESR solid electrolytic capacitors which include a conductive polymer (such as polythiophene) serving as a cathode and a solid electrolyte layer serving as a cathode. However, in production of a solid electrolytic capacitor, after formation of the solid electrolyte layer, it is difficult to proceed with repair of the inner core package, resulting in limitation to the working voltage.

### BRIEF SUMMARY OF THE INVENTION

The technical problems to be solved by the present invention are as follows. A solid electrolytic capacitor serving as a power and for ordinary electronic use generally requires a working voltage below 16 WV. With the increasing demand for high voltage usage and vehicle load, the working voltage requires to be in a range of 25-125 WV while demanding products with excellent reliability and a low ESR.

The present invention provides a solution for the above problems by providing a solid electrolytic capacitor for high-pressure use and containing a non-aqueous solvent or an electrolytic solution.

The electrolytic capacitor comprises a core package formed by stacking and rolling an anode foil, a cathode foil, a plurality of paper spacers, and two terminal leads. The core package includes a solid electrolyte layer. The solid electrolyte layer is impregnated with an electrolytic solution. The electrolytic solution includes an ester compound and a sulfone compound. A content of the ester compound is more than 30% by mass. A content of the sulfone compound is more than 40% by mass. The sum of the contents of the ester compound and the sulfone compound is larger than 90% by mass. Thus, an electrolytic capacitor with excellent reliability is provided.

In an example, the ester compound is selected from the group consisting of γ-butyrolactone, tributyl phosphate, ethyl benzoate, and a combination thereof.

In an example, the sulfone compound is selected from the group consisting of sulfolane, dimethyl sulfoxide, ethyl sulfoxide, benzyl phenyl sulfoxide, and a combination thereof.

In an example, the content of the ester compound is 30-90% by mass.

In an example, the content of the sulfone compound is 40-90% by mass.

In an example, the solid electrolyte layer is formed by dissolving a conductive polymer to obtain a conductive polymer dispersion, soaking the core package in the conductive polymer dispersion, and drying the core package.

In an example, the conductive polymer is selected from the group consisting of polythiophene, its derivatives, and a combination thereof.

Thus, the present invention provides an electrolytic capacitor with excellent reliability.

The present invention will become clearer in light of the following detailed description of illustrative embodiments of this invention described in connection with the drawings.

### DESCRIPTION OF THE DRAWINGS

FIG. 1 is a diagrammatic view of a core package of an embodiment of an electrolytic capacitor according to the present invention.

FIG. 2 is a diagrammatic sectional view of the embodiment of the electrolytic capacitor according to the present invention.

### DETAILED DESCRIPTION OF THE INVENTION

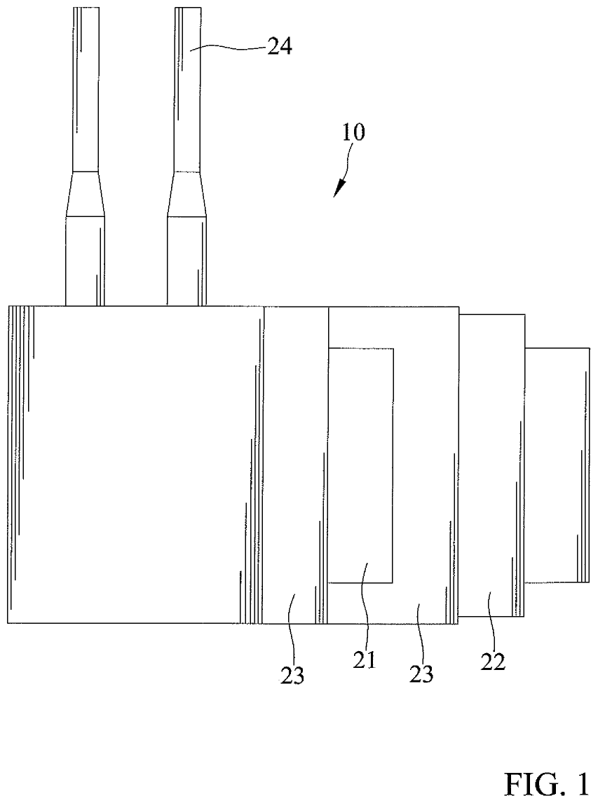

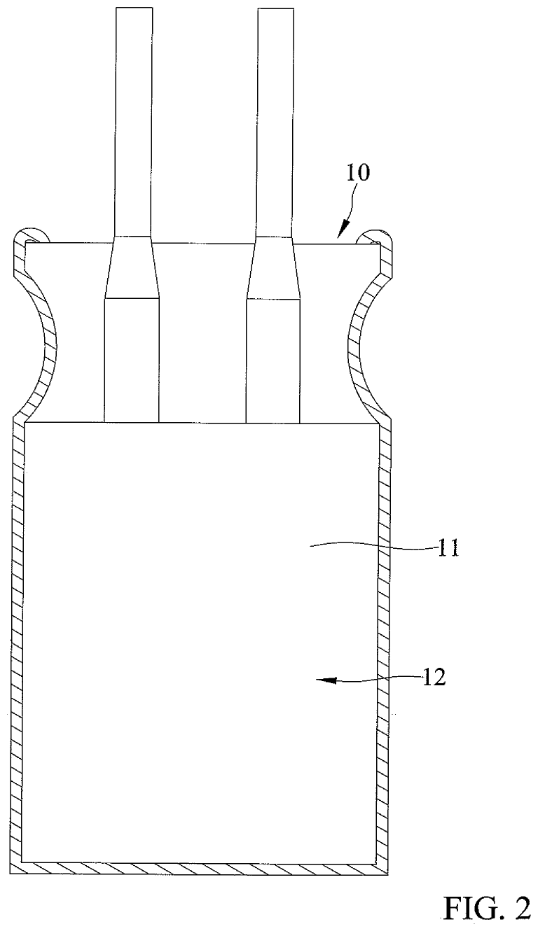

With reference to FIGS. 1-2, the present invention provides an electrolytic capacitor comprising a core package 10 formed by stacking and rolling an anode foil 21, a cathode foil 22, a plurality of paper spacers 23, and two terminal leads 24. The core package 10 includes a solid electrolyte layer 11. The solid electrolyte layer 11 is formed by dissolving a conductive polymer to obtain a conductive polymer dispersion, soaking the core package in the conductive polymer dispersion, and drying the core package 10. The conductive polymer is preferably selected from the group consisting of polythiophene, its derivatives, and a combination thereof.

The solid electrolyte layer 11 is impregnated with an electrolytic solution 12. The electrolytic solution 12 includes a solvent. The solvent includes an ester compound and a sulfone compound.

A content of the ester compound is 30-90% by mass. The ester compound is preferably selected from the group consisting of γ-butyrolactone, tributyl phosphate, ethyl benzoate, and a combination thereof.

A content of the sulfone compound is 40-90% by mass. The sulfone compound is preferably selected from the group consisting of sulfolane, dimethyl sulfoxide, ethyl sulfoxide, benzyl phenyl sulfoxide, and a combination thereof.

The sum of the contents of the ester compound and the sulfone compound is larger than 90% by mass.

A method for manufacturing the electrolytic capacitor according to the present invention includes the following steps: cutting materials, riveting and winding the materials to form a core package, formation, carbonization, impregnation with a polymer, polymerization, impregnation with an electrolytic solution, assembly, charging selection, and processing to obtain the product.

### EXAMPLES

### Example 1

In the following example, a winding type electrolytic capacitor (Φ6.3 mm×L (length) 7.7 mm) having a rated voltage of 63V and a rated electrostatic capacity of 22 μF was produced.

The electrolytic capacitor was produced according to the above steps, and the materials include an anode foil, a cathode foil, paper spacers, terminal leads, fixing tapes, rubber caps, an aluminum hull, a dispersion, and an electrolytic solution.

The electrostatic capacity and the ESR of the produced electrolytic capacitor were tested.

The electrolytic capacitor was evaluated for long-term reliability. When the rated voltage was applied, Example 1 was kept at 135° C. for 1,000 hours to confirm the change rate (ΔDF135) and the increasing rate (ΔESR135) of ESR of the electrostatic capacity.

Similar to Example 1, other examples and comparative examples were produced to obtain electrolytic capacitors. The ester compound or the sulfone compound was or was not used in the electrolytic solution. The above method was used to evaluate these electrolytic capacitors. The results are shown in Tables 1-3.

TABLE 1

| | Electrolytic solution | | | | Evaluation | | | |
|---|---|---|---|---|---|---|---|---|
| | composition | | | | | | Below 135° C. | |
| | Content of each ingredient | | | | initial | | after 1000 Hr | |
| | of solvent | | | | | ESR | ΔDF | ΔESR |
| | GBL | SL | GBL + SL | EG | DF | (mΩ) | (%) | (%) |
| Comparative | 100 | — | — | — | 0.016 | 13.75 | 56.25 | 57.24 |
| example 1 | | | | | | | | |
| Comparative | — | 100 | — | — | 0.016 | 15.58 | 43.75 | 26.51 |
| example 2 | | | | | | | | |
| Comparative | — | — | — | 100 | 0.018 | 12.96 | 600.00 | 332.33 |
| example 3 | | | | | | | | |
| Example 1 | 20 | 40 | 60 | 40 | 0.019 | 12.76 | 1710.53 (500 H, | 160245 (500 H, |
| | | | | | | | stop) | stop) |
| Example 2 | 25 | 45 | 70 | 30 | 0.016 | 12.54 | 1362.50 (500 H, | 50.48 (500 H, |
| | | | | | | | stop) | stop) |
| Example 3 | 30 | 50 | 80 | 20 | 0.015 | 12.94 | 1266.67 | 400.31 |
| Example 4 | 35 | 55 | 90 | 10 | 0.016 | 13.19 | 12.50 | 45.64 |
| Example 5 | 40 | 60 | 100 | — | 0.016 | 13.98 | 37.50 | 41.85 |

GBL: γ -butyrolactone,
SL: sulfolane,
EG: ethylene glycol

Among Examples 1-5, Example 4 showed the best ESR (ΔESR135) and DF (ΔDF135) caused by temperature. The sum of the contents of the ester compound and the sulfone compound was preferably larger than 90% by mass.

TABLE 2

| | Electrolytic solution | | | | Evaluation | | | |
|---|---|---|---|---|---|---|---|---|
| | composition | | | | | | Below 135° C. | |
| | Content of each ingredient | | | | initial | | after 1000 Hr | |
| | of solvent | | | | | ESR | ΔDF | ΔESR |
| | GBL | SL | GBL + SL | EG | DF | (mΩ) | (%) | (%) |
| Comparative | 10 | 80 | 90 | 10 | 0.016 | 13.15 | 12.50 | 60.68 |
| example 5 | | | | | | | | |
| Example 6 | 15 | 75 | 90 | 10 | 0.015 | 12.94 | 13.33 | 48.15 |
| Example 7 | 20 | 70 | 90 | 10 | 0.015 | 12.47 | 13.33 | 53.09 |
| Example 8 | 25 | 65 | 90 | 10 | 0.015 | 12.40 | 0.00 | 41.13 |
| Example 9 | 30 | 60 | 90 | 10 | 0.015 | 12.55 | 20.00 | 39.52 |
| Example 4 | 35 | 55 | 90 | 10 | 0.016 | 13.19 | 12.50 | 45.64 |
| Example 10 | 40 | 50 | 90 | 10 | 0.015 | 12.48 | 13.33 | 35.90 |
| Example 11 | 45 | 45 | 90 | 10 | 0.015 | 12.49 | 20.00 | 35.23 |
| Comparative | 50 | 40 | 90 | 10 | 0.015 | 12.61 | 13.33 | 36.56 |
| example 6 | | | | | | | | |

In Examples 4 and 6-10, the content of the ester compound in the solvent was preferably more than 30% by mass, and the content of the sulfone compound in the solvent was preferably more than 40% by mass.

TABLE 3

| | Electrolytic solution | | | | Evaluation | | | |
|---|---|---|---|---|---|---|---|---|
| | composition | | | | | | Below 135° C. | |
| | Content of each ingredient | | | | initial | | after 1000 Hr. | |
| | of solvent | | | | | ESR | | ΔESR |
| | GBL | SL | GBL + SL | EG | DF | (mΩ) | ΔDF(%) | (%) |
| Comparative | 50 | 40 | 90 | 10 | 0.015 | 12.61 | 13.33 | 36.56 |
| example 6 | | | | | | | | |
| Example 12 | 10 | 90 | 100 | — | 0.016 | 13.84 | 56.25 | 29.55 |
| Example 13 | 20 | 80 | 100 | — | 0.016 | 13.62 | 43.75 | 35.61 |
| Example 14 | 30 | 70 | 100 | — | 0.016 | 13.51 | 37.50 | 40.27 |
| Example 5 | 40 | 60 | 100 | — | 0.016 | 13.98 | 37.50 | 41.85 |
| Example 15 | 50 | 50 | 100 | — | 0.016 | 13.27 | 37.50 | 49.28 |
| Example 16 | 60 | 40 | 100 | — | 0.016 | 13.05 | 31.25 | 39.00 |
| Example 17 | 70 | 30 | 100 | — | 0.016 | 12.93 | 37.50 | 43.16 |

Although specific embodiments have been illustrated and described, numerous modifications and variations are still possible without departing from the scope of the invention. The scope of the invention is limited by the accompanying claims.

1. An electrolytic capacitor comprising a core package formed by stacking and rolling an anode foil, a cathode foil, a plurality of paper spacers, and two terminal leads, wherein the core package includes a solid electrolyte layer, wherein the solid electrolyte layer is impregnated with an electrolytic solution, wherein the electrolytic solution includes an ester compound and a sulfone compound, wherein a content of the ester compound is more than 30% by mass, wherein a content of the sulfone compound is more than 40% by mass, and wherein a sum of the contents of the ester compound and the sulfone compound is larger than 90% by mass.

2. The electrolytic capacitor as claimed in claim 1, wherein the ester compound is selected from the group consisting of γ-butyrolactone, tributyl phosphate, ethyl benzoate, and a combination thereof.

3. The electrolytic capacitor as claimed in claim 1, wherein the sulfone compound is selected from the group consisting of sulfolane, dimethyl sulfoxide, ethyl sulfoxide, benzyl phenyl sulfoxide, and a combination thereof.

4. The electrolytic capacitor as claimed in claim 1, wherein the content of the ester compound is 30-90% by mass.

5. The electrolytic capacitor as claimed in claim 1, wherein the content of the sulfone compound is 40-90% by mass.

6. The electrolytic capacitor as claimed in claim 1, wherein the solid electrolyte layer is formed by dissolving a conductive polymer to obtain a conductive polymer dispersion, soaking the core package in the conductive polymer dispersion, and drying the core package.

7. The electrolytic capacitor as claimed in claim 6, wherein the conductive polymer is selected from the group consisting of polythiophene, its derivatives, and a combination thereof.
